(19) United States
(12) Patent Application Publication
(10) Pub. No.: US 2015/0363879 A1
(43) Pub. Date: Dec. 17, 2015

(54) SYSTEM, METHOD AND COMPUTER-ACCESSIBLE MEDIUM FOR TRADE SURVEILLANCE

(71) Applicant: NEW YORK UNIVERSITY, New York, NY (US)

(72) Inventors: Panagiotis G. Ipeirotis, New York, NY (US); Claudio Silva, New York, NY (US)

(21) Appl. No.: 14/742,474

(22) Filed: Jun. 17, 2015

Related U.S. Application Data
(60) Provisional application No. 62/013,413, filed on Jun. 17, 2014.

(51) Int. Cl. G06Q 40/04

(52) U.S. Cl. CPC G06Q 40/04

(57) ABSTRACT

An exemplary system, method and computer-accessible medium can be provided, which can include, for example, receiving digital data related to a suspicious trade(s), determining a first entity(s) associated with the suspicious trade(s) based on the digital data, and determining a relationship between the first entity(s) and a second entity based(s) on a proximity between the first entity(s) and the second entity(s). The proximity used to determine the relationship can be a logical proximity. The logical proximity can be determined based on a communication(s) between the first entity(s) and the second entity(s).

### CROSS-REFERENCE TO RELATED APPLICATION(S)

This application relates to and claims priority from U.S. Patent Application No. 62/013,413, filed on Jun. 17, 2014, the entire disclosure of which is incorporated herein by reference.

### FIELD OF THE DISCLOSURE

The present disclosure relates generally to insider trading, and more specifically, to exemplary embodiments of an exemplary system, method and computer-accessible medium for trade surveillance.

### BACKGROUND INFORMATION

Insider trading is the trading of a public company's stock or other securities (e.g., bonds or stock options) by individuals with access to nonpublic information about the company. In various countries, including the United States, trading based on insider information is illegal. This is because it is seen as unfair to other investors who do not have access to the information as the investor with insider information could potentially make far larger profits that a typical investor could not make.

Thus, it may be beneficial to provide an exemplary system, method and computer-accessible medium that can identify trades made based on insider trading.

### SUMMARY OF EXEMPLARY EMBODIMENTS

An exemplary system, method and computer-accessible medium can be provided, which can include, for example, receiving digital data related to a suspicious trade(s), determining a first entity(s) associated with the suspicious trade(s) based on the digital data, and determining a relationship between the first entity(s) and a second entity based(s) on a proximity between the first entity(s) and the second entity(s). The proximity used to determine the relationship can be a logical proximity. The logical proximity can be determined based on a communication(s) between the first entity(s) and the second entity(s). The communication(s) can include (i) one or more email communications between the first entity(s) and the second entity(s), (ii) one or more instant messages between the first entity(s) and the second entity(s), (iii) one or more telephone calls between the first entity(s) and the second entity(s), or (iv) one or more text messages between the first entity(s) and the second entity(s).

In some exemplary embodiments of the present disclosure, the logical proximity can be determined based (i) a frequency of an electronic communication between the first entity(s) and the second entity(s), or (ii) metadata associated with the electronic communication between the first entity(s) and the second entity(s). The logical proximity can also be determined based on a relevance of the communication(s), wherein the relevance can be based on a content or a context of the communication(s). The proximity used to determine the relationship can be a physical proximity. The association can include a beneficiary owner of a first account associated with the suspicious trade(s), (ii) a second account connected to a friend or a family member of an employee of a company associated with the suspicious trade(s), or (iii) a third account connected to a trader of the company through trading activity of a holder of the third account. The first entity can be determined by electronically connecting the suspicious trade(s) with a source of insider information(s).

In certain exemplary embodiments of the present disclosure, the source of insider information can include (i) one or more internal memorandums, (ii) one or more email communications, (iii) one or more corporate documents, (iv) one or more documents stored on user's hard drives or (v) one or more documents stored on servers. The insider information can include (i) one or more financial projections, (ii) one or more financial results, (iii) one or more corporate action plans, (iv) one or more mergers, (v) one or more acquisitions, and (v) one or more divestments. The relationship can be determined based on a communication graph(s), which can be generated based on a number of communications between the first entity(s) and the second entity(s).

In some exemplary embodiments of the present disclosure, the number of the communications can be normalized using a log-likelihood procedure. A weight can be applied to the communication(s) graph. In certain exemplary embodiments of the present disclosure, a weight of an edge of the communication(s) graph can be inversely proportional to a frequency of communication between the first entity(s) and the second entity(s). The relationship can be determined based on a suspicion score(s). The second entity(s) can be a plurality of second entities, and a network prominence score can be assigned to each of the second entities, a list of scores can be generated by separately dividing the suspicion score(s) by the network prominence score for each of the second entities, and a particular one of the second entities can be selected based on the list of the scores.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figure(s) showing illustrative embodiments of the present disclosure, in which:

FIG. 1 is a diagram of an exemplary workflow which can be used to identify sources of information among list of restricted entities according to an exemplary embodiment of the present disclosure;

FIG. 2 is diagram illustrating the exemplary identification of potential sources of information when no known entities with insider info are available according to an exemplary embodiment of the present disclosure;

FIG. 3 is a diagram illustrating the exemplary surveillance framework according to an exemplary embodiment of the present disclosure;

FIG. 4 is a flow diagram of an exemplary method for determining a relationship between entities associated with a suspicious trade according to an exemplary embodiment of the present disclosure; and

FIG. 5 is an illustration of an exemplary block diagram of an exemplary system in accordance with certain exemplary embodiments of the present disclosure.

Throughout the drawings, the same reference numerals and characters, unless otherwise stated, are used to denote like features, elements, components or portions of the illustrated embodiments. Moreover, while the present disclosure will now be described in detail with reference to the figures, it is done so in connection with the illustrative embodiments and is not limited by the particular embodiments illustrated in the figures and the appended claims.

### DESCRIPTION OF EXEMPLARY EMBODIMENTS

The exemplary system, method and computer-accessible medium, according to an exemplary embodiment of the present disclosure, can include statistical and analytical capabilities to address surveillance challenges that are non-deterministic in nature (e.g., suspicious trading activities). An exemplary factor that can be accounted for can be “proximity” between entities. These can include both physical proximity (e.g., derived from office/desk location, floor access, department, etc.t) and logical proximity, which can be inferred from, for example, emails, instant messaging, telephone calls, text messages, and other forms of electronic communications.

The exemplary system, method and computer-accessible medium, according to an exemplary embodiment of the present disclosure, can be used to identify factors upon which relationships can be measured and quantified. For example, factors can include (i) the frequency of communications between two entities and change in frequency in the communication, (ii) metadata about the messages, such as size, and/or (iii) existing electronic communication relationships or the formation of workgroups or collections, such as “Friends and Family” in Lync. For example, the exemplary system, method and computer-accessible medium can be used to measure the relevance of some communication (e.g., communication that discusses an issuer that has a material price movement and/or the communication's context that can be unrelated to trading).

The exemplary system, method and computer-accessible medium can utilize logical and/or physical proximity, which can be aggregated/summarized for surveillance purposes. For example, the exemplary system, method and computer-accessible medium, according to an exemplary embodiment of the present disclosure, can combine various exemplary metrics into a procedure with one or two dimensions that can visually and/or digitally demonstrate and/or indicate a logical proximity, as well as assign “scores”, to various considerations, which can be normalized between about 1 to about 100 for proximity as a factor for surveillance

The exemplary system, method and computer-accessible medium, according to an exemplary embodiment of the present disclosure, can utilize an explanatory framework that can allow the users of the Institutional Client Group (“ICG”) Compliance system to more quickly determine whether a given suspicious trading activity has sufficient evidence to support a case for insider trading.

### Exemplary Data

Accounts that have been flagged by the surveillance system including account number, zeta, profitability and security can be used. Additional accounts with no suspicious activity, or even with negative profitability with high zeta, can also be analyzed in order to avoid problems with systematic statistical bias. For example, a person that can be highly connected to accounts with both high, neutral and negative profitability may not be as likely to be involved in insider trading as compared to someone who can be strongly connected to only positive profitability (e.g., high zeta accounts).

The relationship between account and entities can be or include, for example, (i) beneficiary owner of account, (ii) account connected to an employee through friends and family, and/or (iii) account connected to trader through trading activity. It can be beneficial to have all possible connections of entities to trades. Below are exemplary connections between accounts and entities.
1) Entities connected with an account (e.g., Account number, entity, connecting_relationship2).
2) Accounts can be connected based on relationships of the employee with family/relatives/etc. An employee can also be trading for personal benefit.
3) All or many accounts can be connected based on the beneficial owner of these accounts. A customer can be a beneficial owner of multiple accounts.
4) All or most trading activities of the trader can be connected to measure anomalous performance on the aggregate. The trader can be trading to improve returns for customer with or without explicit knowledge of the customer.
5) Communications between the entities (e.g., entity_from, entity_to, date, type).

### Exemplary Identification of Potential Sources of Information Among List of Restricted Entities

The exemplary system, method and computer-accessible medium, according to an exemplary embodiment of the present disclosure, can identify potential sources of information. Sources of information can include, but are not limited to, internal memorandums email communications, corporate documents, documents stored on user's hard drives, documents stored on servers, and various other sources of non-public information. A list of suspicious trades for a given security can be used to identify potential sources of insider information among a list of people that have access to insider information for that security. Insider information can include, but is not limited to, financial projections, financial results, corporate action plans, mergers, acquisitions, divestments and various other non-public information.

### Exemplary Method/Framework

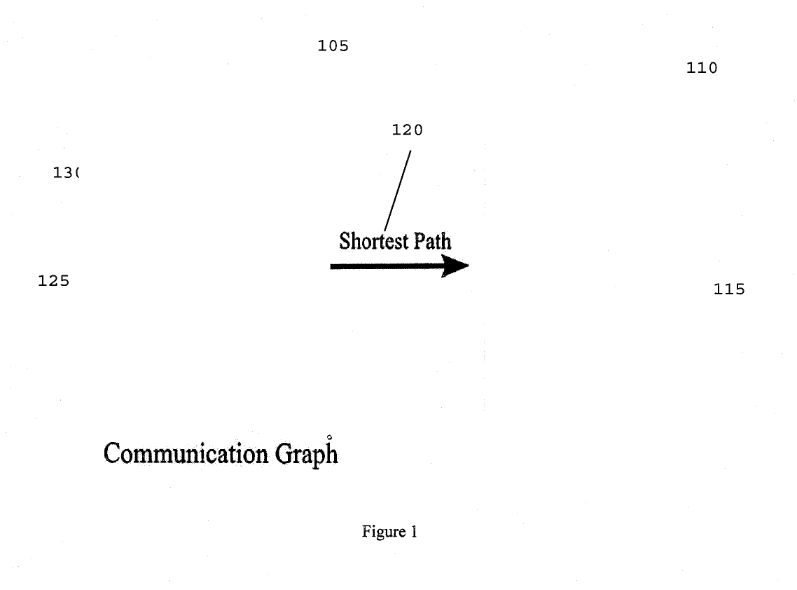

As shown in a diagram of an exemplary configuration/flow of FIG. 1, an exemplary goal can be to determine a path (e.g., the most likely path), such as information path 115, that can connect a suspicious trade 125 with a source of insider information 130 (e.g., most likely source 110). Each trade can belong to an account, and the account can be connected to a set of entities that can act/influence the account. The information can be used to generate an exemplary communication graph 105, and the information in the graph can indicate a flow from one entity to another (e.g., from entity A to entity B), which can be proportional to the frequency of communication between the two entities.

The exemplary communication graph can be generated by connecting entities that can communicate frequently (e.g., entities that communicate at or above a predetermined threshold number of times). The communication graph can be generated by measuring the amount of communications (e.g., emails, chat/instant messages, phone calls, Bloomberg chats/emails, Skype/Lync communications) between two parties, either as 1:1 or 1:many. The counts can then be normalized using a log-likelihood measurement, which can be defined as weight(A→B)=−log(count(A→B)/count (A→*)), where count(A→B) can be the total number of messages from A to B within the time period of interest, and count(A→B*) can be the total number of messages sent from A to any recipient through that same period.

The exemplary graph can be weighted. The weight of an edge that connects two entities A and B can be inversely proportional to the frequency of communication between A and B. Since it can be beneficial to connect all suspicious trades, an exemplary procedure (e.g., Floyd's procedure or Viterbi's procedure) can be used to determine the shortest path or shortest weighted path (e.g., shortest path 120) from each suspicious trade to all the potential sources of information. The exemplary system, method and computer-accessible medium, according to an exemplary embodiment of the present disclosure, can then produce, for each account with suspicious activity, a list of restricted entities in decreasing order of likelihood of leaking the insider information, and for each account and suspected entity, the most likely path that the information followed to reach the account with the suspicious activity. Restricted entities can include entities that the insider information is restricted to.

Exemplary Identification of Potential Sources of Information When No Known Entities with Insider Information are Available

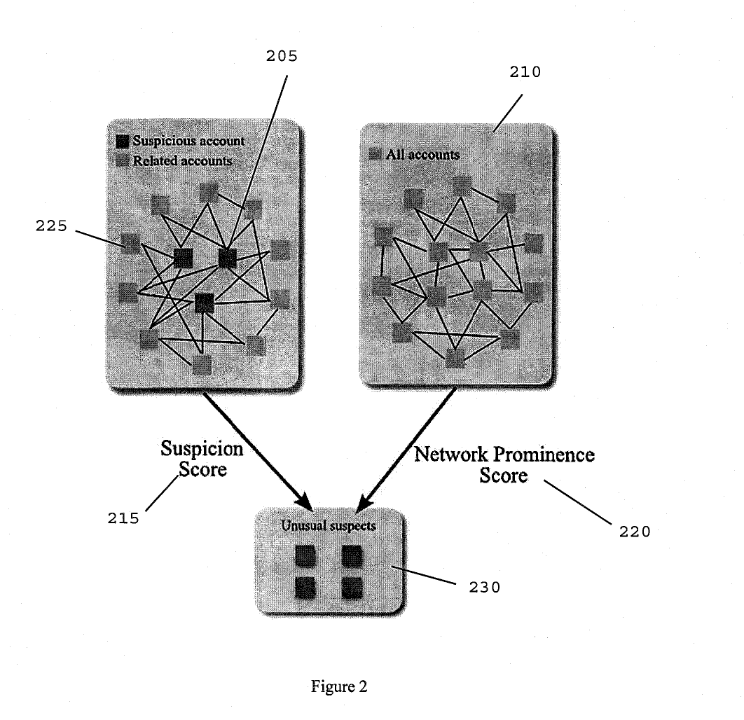

As shown in a diagram of an exemplary configuration/flow of FIG. 2, a list of suspicious trades can be provided for a given security, and potential entities that can be connected with such trades can be identified, even if these entities may not be in the list of entities that have insider knowledge for that security. The exemplary system, method and computer-accessible medium can be used to identify individuals that can be involved in insider trading, even if they may not be in the list of people that have insider knowledge for that security.

The exemplary system, method and computer-accessible medium, according to an exemplary embodiment of the present disclosure, can be used to identify “hot spots” in the network, from which information about a security can be “flowing from.” A “random walk” approach, such as, for example, Google's PageRank for assigning importance to various nodes in the network can be used. An importance can be assigned to the information, for example, to identifying prominent nodes in the insider trading activity network.

Exemplary Suspicion Score: Accounts or entities that have been marked as having suspicious activity (e.g., suspicious accounts 205) can be utilized. These accounts can spread “suspicion” to all entities associated or related with them (e.g., related accounts 225), for example, in a degree proportional to their zeta and profitability. This suspicion can again be spread to the entities that can be connected to them, in a degree that can be proportional to the weight of the communication graph edge. At the end of this exemplary procedure, all nodes can be associated with a suspicion score 215 that can be higher for the nodes that can be “closer” to the suspicious accounts.

Exemplary Normalization: The exemplary suspicion scores computed as described herein may not be able to separate the nodes that can be truly suspicious from the nodes that can have structurally high scores just because they are prominent communication hubs (e.g., a director). To compensate for this potential bias, the exemplary procedure above can be repeated by also including, for example, a sample of all accounts (e.g., accounts 210) whether or not they exhibit unusual activity. The scores assigned by this exemplary analysis can be used by the exemplary system, method and computer-accessible medium, according to an exemplary embodiment of the present disclosure, to identify the overall network prominence score 220 of the various entities. The combination of the suspicion score 215 and the network prominence score 220 can be used to identify unusual suspects 230.

The exemplary system, method and computer-accessible medium, according to an exemplary embodiment of the present disclosure, can divide the suspicion score with the network prominence score. Entities that score high can be those that can be closely connected to trades that can involve unusual activity, while not having the network prominence that may justify such a score. Thus, the exemplary system, method and computer-accessible medium, according to an exemplary embodiment of the present disclosure, can identify entities having a suspicion score that exceeds a predetermined threshold.

A list of entities that can be marked as connected can be used to flag trades, in a degree that may not be seen just by their overall position in the network. In order to flag trades, the exemplary system, method and computer-accessible medium can perform two graph-based analyses, one based on the analysis of the network of trades, and one on the analysis of the communication connections between entities. A cross-analysis of the two networks (e.g., trades and communications) can then be performed. Statistically, in the absence of any insider trading, the two networks can be largely uncorrelated. However, when there are cases of insider trading, the connections between trades can also be expected to be present.

Exemplary Analysis of Trades Network: The networks of suspicious trades and their connected entities can be analyzed according to an exemplary embodiment of the present disclosure. This exemplary network can form an exemplary bipartite graph, which can have two types of nodes. One side of the bipartite graph can contain the trades, and the other side can contain the entities. The structure of this graph can be analyzed to detect potentially unusual patterns. In a first example, the exemplary system, method and computer-accessible medium, according to an exemplary embodiment of the present disclosure, can identify entities that can be connected more than can be expected to the unusual trades, by analyzing the distribution of zeta values of the trades connected with each entity. “Suspicious neighborhood of trades” can also be identified, which can be performed by “folding” the graph into a trade-to-trade graph, by linking trades that can be connected to the same entity. If clustering of high zeta values in particular areas of the graph is detected, these can become points of concern. A high concentration of zeta values can even occur without the existence of any individual outlier zeta values, although the “neighborhood” can have unusual average zeta values. (“zeta of zeta's”?). Unusual clustering of entities around suspicious trades can also be identified. Trades that exceed a zeta threshold can be stored, and the trades-account graph can be transformed into an account-account graph. A matrix decomposition operation (e.g., SVD) can be performed to identify clusters of entities. In the absence of unusual activity, there should not be any cluster forming.

Exemplary Analysis of Communication Network: The network of communications between entities can be analyzed. What exactly constitutes an “edge” among two entities can vary. For example, the exemplary system, method and computer-accessible medium, according to an exemplary embodiment of the present disclosure, can connect two entities when the amount/frequency of communication between two entities can be higher than usual. To make the connection with the trade analysis, it can have a high “zeta” value. Two entities can be connected whenever the message between the two accounts can contain a mention of a company in the restricted list, or with material market event. Two entities can also be connected based on an unusual amount of communication, after taking into consideration the usual amount of communication between people of such physical proximity, or people within the same team. The exemplary analysis of the generated graph can be similar as in the case of the trade network to identify clusters of entities in the graph that can have unusual properties.

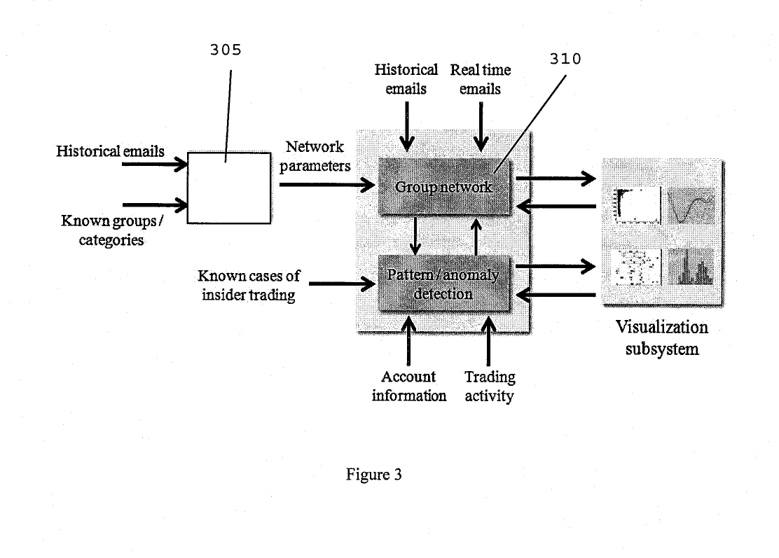

Exemplary Cross Analysis of Communication and Trade Network: As shown in a diagram of an exemplary configuration/flow of FIG. 3, networks formed based on unusual trading activity can be uncorrelated to the network formed based on unusual communication activity, in the absence of insider trading. Various exemplary properties of the entities in the two graphs can be analyzed and plotted within a visualization framework (e.g., axis 1: property in communication graph, axis 2: property in trade graph), and can be used to visually identify cases of interest. Historical emails, together with prior known information about existing “logical proximity” and/or known groups/categories, can be used to infer parameters that can model the proximity network (e.g., model 305). These parameters can then be used to compute the base proximity network or group network 310. Similarly, historical emails, and known instances of insider trading activity, can be used to learn the parameters to model and identify relevant emails (e.g., using pattern/anomaly detection 315). The arrival of newer emails can update the network in real-time. The newer emails, together with the updated network, can then be analyzed to detect potential trading activity. The visualization (e.g., visual analytics) subsystem can facilitate the user to view properties of the potential insider trading events. Using this exemplary interface, users can select and further analyze specific sets of events based on these properties. Users can also use this information to further tweak the exemplary model parameters. The exemplary models used for the exemplary insider trading event tracking system can be further improved using account details and trading activities of the employees.

### Exemplary Data

Exemplary data can include information on the volume of the available data, to determine the needs for data storage and processing power. Data can also include (i) email/voice messages from one entity to another, (ii) content of the messages if available, (iii) zeta values of trades (e.g., after MME/profitability analysis) and the entities with which these trades are associated, and/or (iv) information of existing groups, known cases of insider trading.

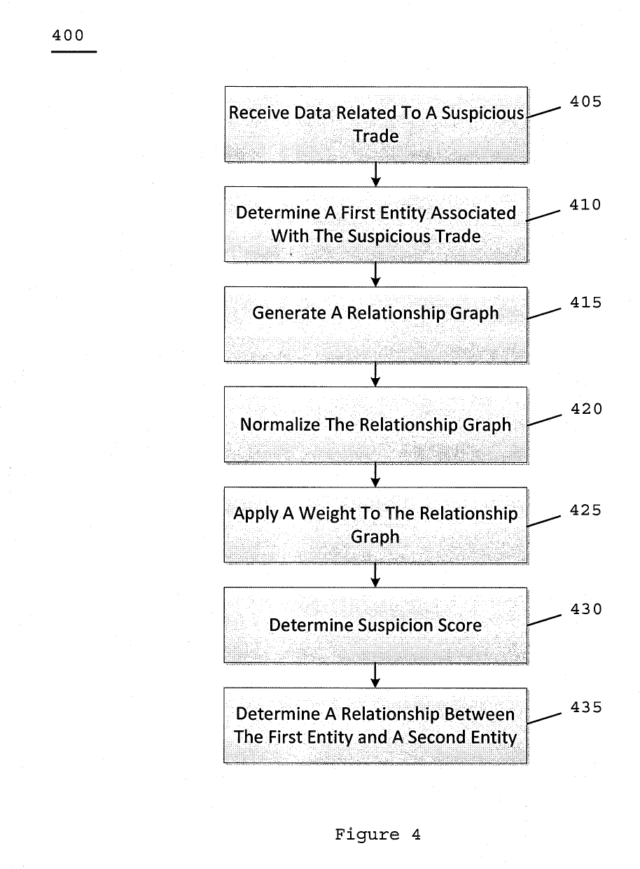

FIG. 4 is a flow diagram of an exemplary method 400 for determining a relationship between entities associated with a suspicious trade according to an exemplary embodiment of the present disclosure. For example, at procedure 405, data related to a suspicious trade can be received. At procedure 410, a first entity associated with the suspicious trade can be determined. A relationship graph, based on the first entity, can be generated at procedure 415, which can be normalized at procedure 420, and weighted at procedure 425. Additionally, or in the alternative, a score can be generated at procedure 430, which can be based on a suspicion score, and a network prominence score assigned to each of a plurality of entities. At procedure 435, a relationship between the first entity and a second entity can be determined.

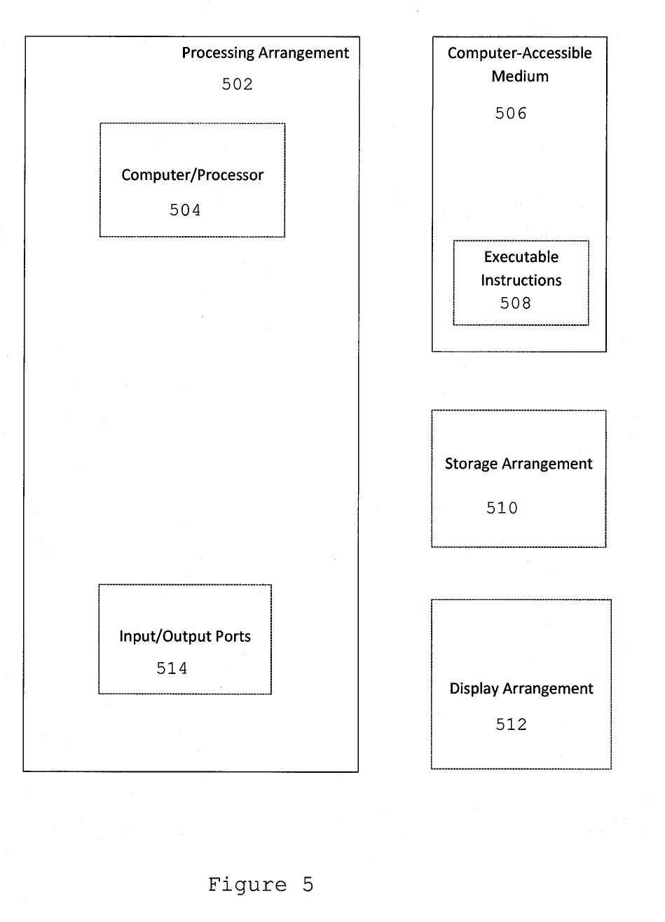

FIG. 5 shows a block diagram of an exemplary embodiment of a system according to the present disclosure. For example, exemplary procedures in accordance with the present disclosure described herein can be performed by a processing arrangement and/or a computing arrangement 502. Such processing/computing arrangement 502 can be, for example entirely or a part of, or include, but not limited to, a computer/processor 504 that can include, for example one or more microprocessors, and use instructions stored on a computer-accessible medium (e.g., RAM, ROM, hard drive, or other storage device).

As shown in FIG. 5, for example a computer-accessible medium 506 (e.g., as described herein above, a storage device such as a hard disk, floppy disk, memory stick, CD-ROM, RAM, ROM, etc., or a collection thereof) can be provided (e.g., in communication with the processing arrangement 502). The computer-accessible medium 506 can contain executable instructions 508 thereon. In addition or alternatively, a storage arrangement 510 can be provided separately from the computer-accessible medium 506, which can provide the instructions to the processing arrangement 502 so as to configure the processing arrangement to execute certain exemplary procedures, processes and methods, as described herein above, for example.

Further, the exemplary processing arrangement 502 can be provided with or include an input/output arrangement 514, which can include, for example a wired network, a wireless network, the internet, an intranet, a data collection probe, a sensor, etc. As shown in FIG. 5, the exemplary processing arrangement 502 can be in communication with an exemplary display arrangement 512, which, according to certain exemplary embodiments of the present disclosure, can be a touch-screen configured for inputting information to the processing arrangement in addition to outputting information from the processing arrangement, for example. Further, the exemplary display 512 and/or a storage arrangement 510 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, for example, data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entirety.
[1] [De Choudury et al, WWW 2010] Inferring relevant social networks from interpersonal communication (WWW10) http://dl.acm.org/citation.cfm?id=1772722
[2] Fast Generalized Subset Scan for Anomalous Pattern Detection (JMLR13) http://www.cs.cmu.edu/˜.neill/papers/mcfowland13a.pdf
[3] Using Topological Analysis to Support Event-Guided Exploration in Urban Data https://www.dropbox.com/s/9lrt2t4kbewgykm/submitted-127.pdf and (video of tool in action) https://www.dropbox.com/s/h8pk44jlzgvgljh/submitted-127.mp4
[4] Inferring Network Structure Relationship over Mobile Phone Data http://www.pnas.org/content/106/36/15274.long
[5] Inferring the Maximum Likelihood Hierarchy in Social Networks http://arun.maiya.net/papers/maiya_etal-hierarchy.pdf
[6] Inferring Colocation and Conversation Networks from Privacy-Sensitive Audio with Implications for Computational Social Science http://dl.acm.org/citation.cfm?id=1889688
[7] Visual Analysis of Large Heterogeneous Social Networks by Semantic and Structural Abstraction http://eliassi.org/papers/shen-tveg06.pdf
[8] Analyzing Social Media Networks with NodeXL: Insights from a Connected World http://nodexl.codeplex.com/
[9]Social Network Discovery based on Sensitivity Analysis http://www.carloscorrea.com/docs/asonam09.pdf
[10] Bursty and Hierarchical Structure in Streams http://www.cs.cornell.edu/home/kleinber/bhs.pdf

What is claimed is:

1. A non-transitory computer-accessible medium having stored thereon computer-executable instructions, wherein, when a computer arrangement executes the instructions, the computer arrangement is configured to perform procedures, comprising:
receiving digital data related to at least one suspicious trade;
determining at least one first entity associated with the at least one suspicious trade based on the digital data; and
determining a relationship between the at least one first entity and at least one second entity based on a proximity between the at least one first entity and the at least one second entity.

2. The computer-accessible medium of claim 1, wherein the proximity used to determine the relationship is a logical proximity.

3. The computer-accessible medium of claim 2, wherein the computer arrangement is further configured to determine the logical proximity based on at least one communication between the at least one first entity and the at least one second entity.

4. The computer-accessible medium of claim 3, wherein the at least one communication includes at least one of (i) one or more email communications between the at least one first entity and the at least one second entity, (ii) one or more instant messages between the at least one first entity and the at least one second entity, (iii) one or more telephone calls between the at least one first entity and the at least one second entity, or (iv) one or more text messages between the at least one first entity and the at least one second entity.

5. The computer-accessible medium of claim 2, wherein the computer arrangement is further configured to determine the logical proximity based on at least one of (i) a frequency of an electronic communication between the at least one first entity and the at least one second entity, or (ii) metadata associated with the electronic communication between the at least one first entity and the at least one second entity.

6. The computer-accessible medium of claim 3, wherein the computer arrangement is further configured to determine the logical proximity based on a relevance of the at least one communication, wherein the relevance is based on at least one of a content or a context of the at least one communication.

7. The computer-accessible medium of claim 1, wherein the proximity used to determine the relationship is a physical proximity.

8. The computer-accessible medium of claim 1, wherein the association includes at least one of a beneficiary owner of a first account associated with the at least one suspicious trade, (ii) a second account connected to at least one of a friend or a family member of an employee of a company associated with the at least one suspicious trade, or (iii) a third account connected to a trader of the company through trading activity of a holder of the third account.

9. The computer-accessible medium of claim 1, wherein the computer arrangement is further configured to determine the at least one first entity by electronically connecting the at least one suspicious trade with at least one source of insider information.

10. The computer-accessible medium of claim 9, where the source of insider information includes (i) one or more internal memorandums, (ii) one or more email communications, (iii) one or more corporate documents, (iv) one or more documents stored on user's hard drives, or (v) one or more documents stored on servers.

11. The computer accessible medium of claim 10, wherein the insider information includes (i) one or more financial projections, (ii) one or more financial results, (iii) one or more corporate action plans, (iv) one or more mergers, (v) one or more acquisitions, and (v) one or more divestments.

12. The computer-accessible medium of claim 1, wherein the computer arrangement is further configured to determine the relationship based on at least one communication graph.

13. The computer-accessible medium of claim 12, wherein the computer arrangement is further configured to generate the at least one communication graph based on a number of communications between the at least one first entity and the at least one second entity.

14. The computer-accessible medium of claim 14, wherein the computer arrangement is further configured to normalize the number of the communications using a log-likelihood procedure.

15. The computer-accessible medium of claim 12, wherein the computer arrangement is further configured apply a weight to the at least one communication graph.

16. The computer-accessible medium of claim 12, wherein a weight of an edge of the at least one communication graph is inversely proportional to a frequency of communication between the at least one first entity and the at least one second entity.

17. The computer-accessible medium of claim 1, wherein the computer arrangement is further configured to determine the relationship based on at least one suspicion score.

18. The computer-accessible medium of claim 17, wherein the at least one second entity is a plurality of second entities, and wherein the computer arrangement is further configured to:
assign a network prominence score to each of the second entities,
generate a list of scores by separately dividing the at least one suspicion by the network prominence score for each of the second entities; and
select a particular one of the second entities based on the list of the scores.

19. A method, comprising:
receiving digital data related to at least one suspicious trade;
determining at least one first entity associated with the at least one suspicious trade based on the digital data; and
using a computer hardware arrangement, determining a relationship between the at least one first entity and at least one second entity based on a proximity between the at least one first entity and the at least one second entity.

20. A method, comprising:
a computer hardware arrangement configured to:
receive digital data related to at least one suspicious trade;
determine at least one first entity associated with the at least one suspicious trade based on the digital data; and
determine a relationship between the at least one first entity and at least one second entity based on a proximity between the at least one first entity and the at least one second entity.
